(19) United States
(12) Patent Application Publication
(10) Pub. No.: US 2006/0279559 A1
(43) Pub. Date: Dec. 14, 2006

(54) Mobile communications terminal and method therefore

(76) Inventors: Wang Kongqiao, Beijing (CN); Gao Yipu, Beijing (CN); Jari Kangas, Tampere (FI)

Correspondence Address: PERMAN & GREEN, 425 POST ROAD, FAIRFIELD, CT, 06824, US

(21) Appl. No.: 11/149,931

(22) Filed: Jun. 10, 2005

(51) Int. Cl. G09G 5/00

(52) U.S. Cl. 345/179

(57) ABSTRACT

An apparatus for handwriting recognition has a display screen providing a handwriting input area capable of detecting input from a user. A processing device is coupled to the display screen and provides a handwriting user interface to the user. The handwriting user interface is operable in at least a first mode and a second mode. A control panel in the handwriting user interface allows selection of said first or second mode. The processing device is adapted to receive an input from the user and to detect, in the input received from the user, a control panel invoking command. In response to detecting the control panel invoking command, the control panel is presented on the display screen. Then, in response to a predetermined event, the control panel is automatically removed from presentation on the display screen, therefore only occupying display space when really needed.

### FIELD OF THE INVENTION

The present invention relates to electronic handwriting equipment, and more particularly to an apparatus for handwriting recognition having a handwriting user interface operable in at least a first mode and a second mode, which are selectable by a control panel. The invention also relates to an associated method for handwriting recognition.

### BACKGROUND OF THE INVENTION

Examples of electronic handwriting equipment include personal assistants (PDAs), hand-held computers (palmtops) and mobile terminals for telecommunication (mobile phones). These apparatuses have in common that they make use of a stylus and a touch-sensitive display screen, a solution that offers improved usability and flexibility compared to conventional user interfaces with a keypad or keyboard.

In an apparatus that accepts user input by way of a stylus and a touch-sensitive display screen, the stylus normally plays two roles; sometimes it functions like a normal pen (“logical pen”) for writing and sometimes like a control device (“logical mouse”) for controlling the user interface.

A general problem with electronic handwriting equipment is that there are some important design factors that are more or less in conflict with each other. On the one hand, it is desired to provide a handwriting input area on the touch-sensitive display screen which is as large as possible, to the benefit of the user. On the other hand, there is a strong trend towards smaller and smaller apparatus sizes for portable devices in general, including electronic handwriting equipment. Obviously, a smaller apparatus size affects the maximum space that is available for the touch-sensitive display screen and therefore also limits the size of the handwriting input area. Consequently, designing electronic handwriting equipment is often a trade-off between maximizing the size of the handwriting input area and minimizing the total apparatus size.

Often, the user interface of an electronic handwriting apparatus is operable in different modes, each related to a respective aspect of handwriting. For instance, it is very common in electronic handwriting equipment to provide one mode for each of a number of different symbol sets or character sets. The accuracy of the handwriting recognition is generally better for restricted symbol sets with a smaller number of symbols than for symbol sets with a larger number of symbols. One well-known example is the close similarity between the lower-case Latin “l” and the Arabic numeral “1”. By dividing all the various possible symbols, that a user may want to input by electronic handwriting, into different symbol sets and assigning each symbol set to a respective mode, the user may select which mode that is to be the currently active one and thereby improve the accuracy and speed of his electronic handwriting, since whatever symbol he writes will be interpreted against only the symbols that are included in the symbol set assigned to the currently active mode. A common disposition of symbol sets is to include Latin letters in one or two symbol sets (upper case and lower case), whereas numeric symbols (e.g. Arabic numerals and mathematic signs) are included in another symbol set. Additionally, non-western symbols such as Chinese characters may be included in yet other symbol sets.

The prior art generally suggests two different approaches of controlling which symbol set to use for matching against a hand-written input in handwriting recognition:

1. Dividing the handwriting input area into different sub areas, where each sub area represents a certain symbol set. These sub areas may be formed as limited-sized input boxes, each of which having a size and shape suitable for about one hand-written symbol. In other words, the user will write one hand-written symbol at a time within such an input box, and the handwriting recognition engine of the apparatus will apply the symbol set associated with this input box. A drawback with such input boxes is that they constantly occupy parts of the touch-sensitive display screen and therefore prevent these parts from being used for other purposes, such as presenting information or control objects in the user interface. This drawback is particularly pronounced if several symbol sets, and thus several input boxes, are available.

Alternatively, like in the P800/P900/P910 series of PDA-type mobile phones from Sony Ericsson, the entire handwriting input area may be logically divided so that hand-written input in the upper region of the handwriting input area is interpreted by the handwriting recognition engine as numeric input, whereas hand-written input along a horizontal center region of the handwriting input area is interpreted as upper-case Latin letters, and hand-written input in the lower region of the handwriting input area is interpreted as lower-case Latin letters. A drawback with this solution is that the meaning of each region is not automatically intuitive to the user. Particularly after a period of inactivity, the user may find it difficult to remember whether e.g. upper-case letters are to be written in the lower region, center region or upper region. Also, the solution is non-flexible in the sense that the user interface cannot be easily expanded from three different available symbol sets to e.g. four.

2. Setting the current mode by performing a predetermined action in the user interface, such as selecting a menu option or clicking a logical button on the touch-sensitive display screen, or pressing a dedicated physical key on a keypad that toggles between e.g. numeric symbol set, upper-case letters and lower-case letters. The drawback with this alternative is that it requires the user to remove, the stylus from the current handwriting activity and move it to another location on the touch-sensitive display screen for selection of the menu option or clicking the logical button, or even dropping the stylus to depress the key on the keypad. Since the user's focus is momentarily switched from the handwriting activity to another action and then back again to handwriting, the quality of the handwriting will suffer both from a speed reduction and probably also a drop in accuracy.

An alternative is to write a special control stroke that has a predefined meaning and that will cause the handwriting functionality to interpret the succeeding handwriting input as belonging to a certain symbol set.

Still an alternative is to provide a control panel or mode selection bar, having selectable elements for the different available symbol sets. The control panel has a certain location preferably within or adjacent to the handwriting input area. By tapping with the stylus on a particular element in the control panel, the mode, i.e. symbol set, associated therewith will become the currently active one. This is intuitive to the user, since the meaning of each selectable element in the control panel can be visually indicated by designing the element as a graphical icon or button. Moreover, the control panel can conveniently be redesigned to represent new modes (symbol sets) by adding new elements to the control panel, or changing the meaning and visual appearance of existing ones. A drawback, however, is that the control panel will occupy a considerable part of the handwriting input area and will therefore reduce the actual available area for handwriting input.

U.S. Pat. No. 6,567,549, in FIG. 7 thereof, illustrates the user interface of an electronic handwriting apparatus in the form of a palmtop computer, where the display has different limited character input boxes 710, 760, 750. U.S. Pat. No. 6,567,549 is an example where the two different approaches described above are combined. The leftmost character input box 710 is dedicated for Japanese Kanji symbols, and the rightmost box 750 is dedicated for Arabic numerals. The center box 760 is a combined input box for inputting Japanese Hiragana characters, Japanese Katakana characters or Western Roman characters depending on the current input mode. The current input mode for the center box 760 is selected by the user by tapping the stylus on a corresponding Hiragana, Katakana or Roman mode box, these mode boxes being provided as graphical icons adjacently to the character input boxes.

### SUMMARY OF THE INVENTION

In view of the above, an objective of the invention is to solve or at least reduce the problems discussed above. More specifically, a purpose of the invention is to provide an improved manner for the user to control the current mode of handwriting in the apparatus, particularly so that the mode selection actions are intuitively and conveniently accessible to the user, preserving valuable space on the display screen at the same time.

Generally, the above objectives and purposes are achieved by an apparatus and a method for handwriting recognition according to the attached independent patent claims.

A first aspect of the invention is an apparatus for handwriting recognition, the apparatus comprising:

a display screen, such as a touch-sensitive display screen, providing a handwriting input area capable of detecting input from a user;

a processing device coupled to the display screen and providing a handwriting user interface to said user, said handwriting user interface being operable in at least a first mode and a second mode; and

a control panel in said handwriting user interface for selecting said first or second mode;

wherein said processing device is adapted to:

receive an input from said user,

detect, in the input received from said user, a control panel invoking command, in response to detecting the control panel invoking command, cause presentation of said control panel on said display screen, and

in response to a predetermined event, remove said control panel from presentation on said display screen.

In this way, whenever a switch in mode is desired, the user may conveniently perform the control panel invoking command to bring about the control panel. Then, once the predetermined event has occurred, the control panel will automatically disappear from the display screen. Thus, the control panel will only be present and occupy space on the display screen when it is needed, i.e. when the user is about to make a switch in mode. During other periods of time, the control panel will be absent and therefore not steal any valuable space on the display screen.

Advantageously, the control panel invoking command is a predefined handwriting action made by the user with a writing tool on the display screen. More specifically, in one embodiment the user may cause the predefined handwriting action by pointing with the writing tool at an arbitrary position on the display screen and keep the writing tool stationary at this position for at least a predetermined time period without removing it from pointing—i.e. making a “long-press” on the display screen with the writing tool. In a practical implementation, a “stationary” pointing position may be defined as a very small region confined to the immediate vicinity of the actual position at which the writing tool is first placed, to allow accidental minor movements of the writing tool caused by hand wobbling of a user which tries and intends to keep the writing tool still so as to command invocation of the control panel. In another embodiment the user may point a first time with his writing tool at an arbitrary position on the display screen, remove the writing tool from pointing at this position, and point a second time with the writing tool at substantially the same position within a predetermined time period—i.e. “double-clicking” on the display screen with the writing tool.

Alternatively, the predefined handwriting action may be caused by the user by performing a predetermined gesture with the writing tool on the display screen. Such a predetermined gesture may involve writing a predetermined symbol which is different from symbols for which handwriting recognition is performed—i.e. a control symbol. The predetermined gesture may otherwise involve writing a predetermined symbol having a size which is substantially different from a typical size of symbols for which handwriting recognition is performed, i.e. a symbol which is either much smaller or much larger than the typical size of ordinary symbols. Still an alternative is that the predetermined gesture involves drawing a stroke which crosses at least a predetermined part of said handwriting input area, such as a diagonal stroke across a major part of the handwriting input area.

In some embodiments, the predetermined gesture is configurable by the user. In other words, the user may himself decide the particulars of the or each gesture that will cause presentation of the control panel. To this end, the user may enter a special settings routine in the user interface and either input the desired gesture by writing its symbol on the display screen, or select the desired gesture from a group of predefined gestures/symbols. Making the predetermined gesture configurable by the user is beneficial in that it allows each user to use the gesture that is the most convenient to him. In turn, this is likely to increase both the input speed and the recognition accuracy of handwriting, since a convenient gesture often would mean a gesture that could be entered both rapidly and accurately by the particular user.

Advantageously, the predetermined event is the detection of an action made with a writing tool within said control panel or said handwriting input area. More specifically, in one embodiment, the control panel comprises a first selectable item for selection of said first mode and a second selectable item for selection of said second mode, wherein aforesaid action made with the writing tool is when the user selects one of the first and second items with the writing tool.

In an alternative embodiment, the predetermined event is the absence of an action made with a writing tool within said control panel during a predetermined time. In other words, if the user remains inactive until the lapse of a timeout period (the duration of which may be configurable by the user), this will trigger the removal of the control panel from the display screen.

The handwriting recognition preferably involves interpreting hand-written user input in the handwriting input area as a symbol among predefined symbols, wherein said first and second modes are associated with first and second sets of predefined symbols, respectively, to be used for the interpretation of hand-written user input.

These first and second sets of predefined symbols may be selected from the group consisting of: Latin characters, upper case characters, lower case characters, Arabic numerals, punctuation symbols, Cyrillic characters, Chinese symbols, Japanese Kanji symbols, Japanese Hiragana characters, Japanese Katakana characters, Korean Hangeul symbols, and user-defined symbols.

In some embodiments, the handwriting user interface is further operable in at least a third mode, said control panel being adapted for selecting between any of said first, second and third modes, wherein said third mode is associated with a third set of predefined symbols to be used for the interpretation of hand-written user input.

The control panel may have an adaptive location within said handwriting input area on said display screen. To this end, the processing device may be configured to adjust the adaptive location depending on at least one of the following: a current cursor position or a current point of actuation on said display screen with a writing tool. Alternatively, the control panel may have a fixed location within-the handwriting input area.

For maximum writing space, the handwriting input area is advantageously formed by a majority of the display screen's available presentation area, or even essentially the entire presentation area. In some embodiments, though, the handwriting input area may be limited to at least one dedicated handwriting character input box which occupies only a part of the display screen's entire available presentation area.

As used herein, “handwriting” means making a stroke, or a sequence of successive strokes within short time intervals, on the display screen by way of a writing tool in the form of a pen, stylus or any pen-like object including a user's finger or other body part. Such strokes are referred to as “pen strokes” in the remainder of this document.

The processing device may be configured to display, on the display screen, a graphical trace representing a pen stroke prior to the interpretation thereof. Moreover, the processing device may be configured to display, on the display screen, the symbol when it has been interpreted from the pen stroke.

The processing device advantageously includes or cooperates with a handwriting recognition engine which may be implemented as hardware, software or any combination thereof.

The apparatus may be a mobile terminal for a mobile telecommunications system, such as GSM, UMTS, D-AMPS or CDMA2000, or a portable/personal digital assistant (PDA), or another type of similar device.

A second aspect of the invention is a method for handwriting recognition in an apparatus having a display screen with a handwriting input area capable of detecting input from a user, the display screen being included in a handwriting user interface which is operable in at least a first mode and a second mode, the method involving the steps of:

receiving an input from said user;

detecting, in the input received from said user, a control panel invoking command;

causing presentation on said display screen of a control panel suitable for selection of said first or second mode;

detecting the occurrence of a predetermined event; and

removing said control panel from presentation on said display screen.

The second aspect has generally the same features and advantages as the first aspect.

Thus, the step of detecting the control panel invoking command may involve detecting a predefined handwriting action made with a writing tool on said display screen, e.g. detecting that said user points with said writing tool on said display screen at a stationary position thereon for at least a predetermined time period without removing said writing tool from pointing, or detecting that said user points a first time with said writing tool on said display screen at a position thereon, removes said writing tool from pointing at said position, and points a second time with said writing tool at said position within a predetermined time period.

Moreover, the step of detecting the control panel invoking command may involve detecting that said user performs a predetermined gesture with said writing tool on said display screen. Such a predetermined gesture may include one of the following: writing a predetermined symbol different from symbols for which handwriting recognition is performed; writing a predetermined symbol having a size which is substantially different from a typical size of symbols for which handwriting recognition is performed; and drawing a stroke which crosses at least a predetermined part of said handwriting input area.

The step of detecting the occurrence of a predetermined event may involve detecting an action made with a writing tool within said control panel or said handwriting input area. Alternatively, it may involve detecting that an action has not been made with a writing tool within said control panel during a predetermined time.

The control panel may comprise a first selectable item for selection of said first mode and a second selectable item for selection of said second mode, wherein the action made with said writing tool within said control panel involves selecting one of said first and second items.

When the handwriting recognition involves interpreting hand-written user input in the handwriting input area as a symbol among predefined symbols, the first and second modes may be associated with first and second sets of predefined symbols, respectively, to be used for the interpretation of hand-written user input. The handwriting user interface may further be operable in at least a third mode, wherein the control panel will be adapted for selecting between any of said first, second and third modes and wherein said third mode will be associated with a third set of predefined symbols to be used for the interpretation of hand-written user input.

The method may involve the steps of determining a current cursor position on said display screen; and adjusting an adaptive location of said control panel within said handwriting input area on said display screen depending on the determined cursor position. Alternatively, it may involve the steps of determining a current point of actuation on said display screen with a writing tool; and adjusting an adaptive location of said control panel within said handwriting input area on said display screen depending on the determined point of actuation.

Other objectives, features and advantages of the present invention will appear from the following detailed disclosure, from the attached dependent claims as well as from the drawings.

### BRIEF DESCRIPTION OF THE DRAWINGS

The present invention will now be described in more detail, reference being made to the enclosed drawings.

FIG. 1 is a schematic illustration of a telecommunications system, including an apparatus for handwriting recognition in the form of a mobile terminal, as an example of an environment in which the present invention may be applied.

FIG. 2a is a schematic front view of an embodiment of the apparatus for handwriting recognition shown in FIG. 1, illustrating in more detail its user interface which includes a touch-sensitive display screen for operation by way of a pen, stylus or similar writing tool.

FIGS. 2b-f are a schematic step-wise illustration of how handwriting is performed and how a mode-selecting control panel is invoked and used for selection between different symbol sets.

FIG. 3 is a schematic block diagram of the hardware and software structure of the apparatus of FIGS. 1 and 2a-f.

FIGS. 4a-4i disclose a sequence of display screen snapshots taken from a practical implementation of the apparatus when used for inputting a hand-written text made of symbols from both a Chinese symbol set and a Latin character set.

FIGS. 5a-5j disclose a sequence of display screen snapshots taken from another practical implementation of the apparatus when used for inputting the hand-written text of FIGS. 4a-4i.

FIG. 6 is a flowchart which illustrates the steps of a method for handwriting recognition according to the invention.

### DETAILED DESCRIPTION OF THE INVENTION

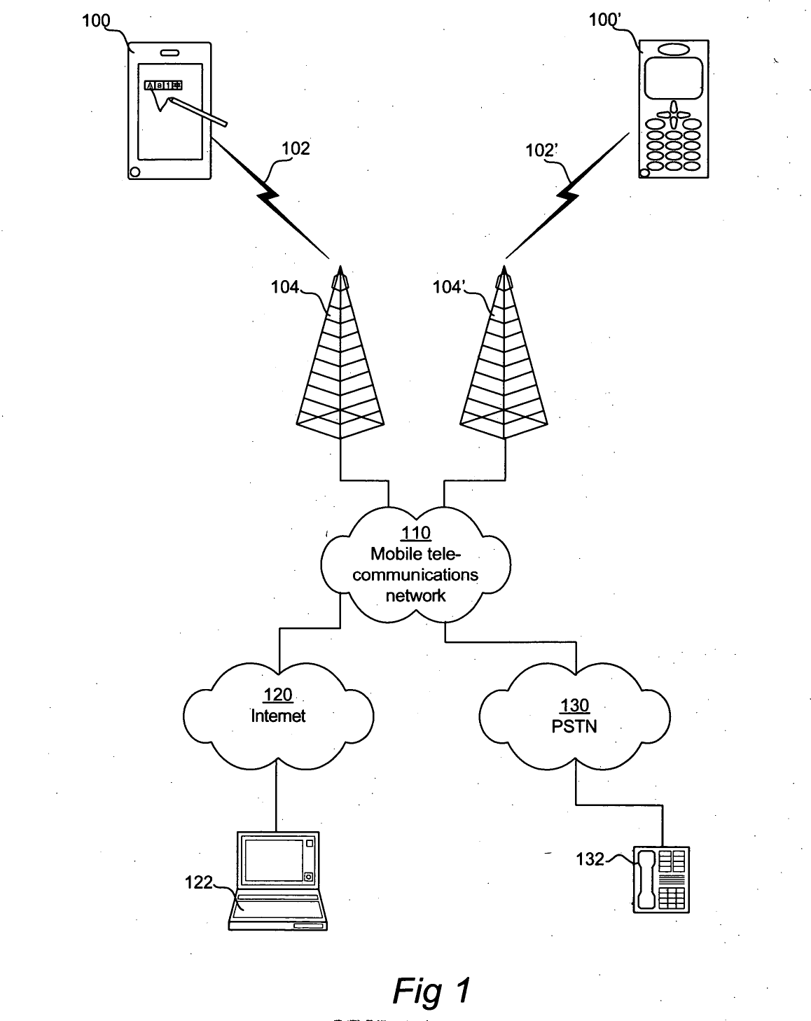

A telecommunications system in which the present invention may be applied will first be described with reference to FIG. 1. Then, the particulars of the apparatus and method according to embodiments of the invention will be described with reference to the remaining FIGS.

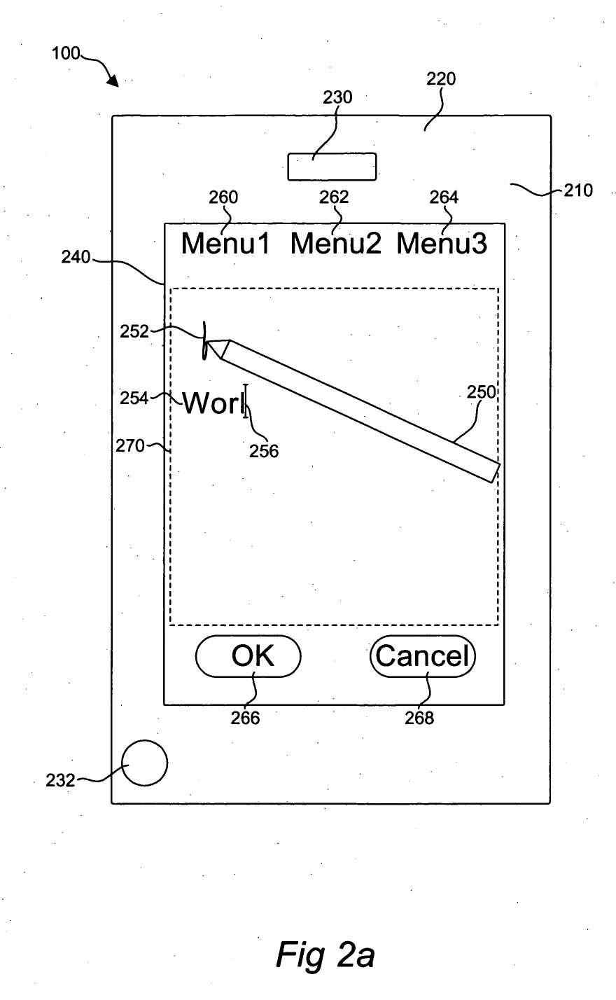

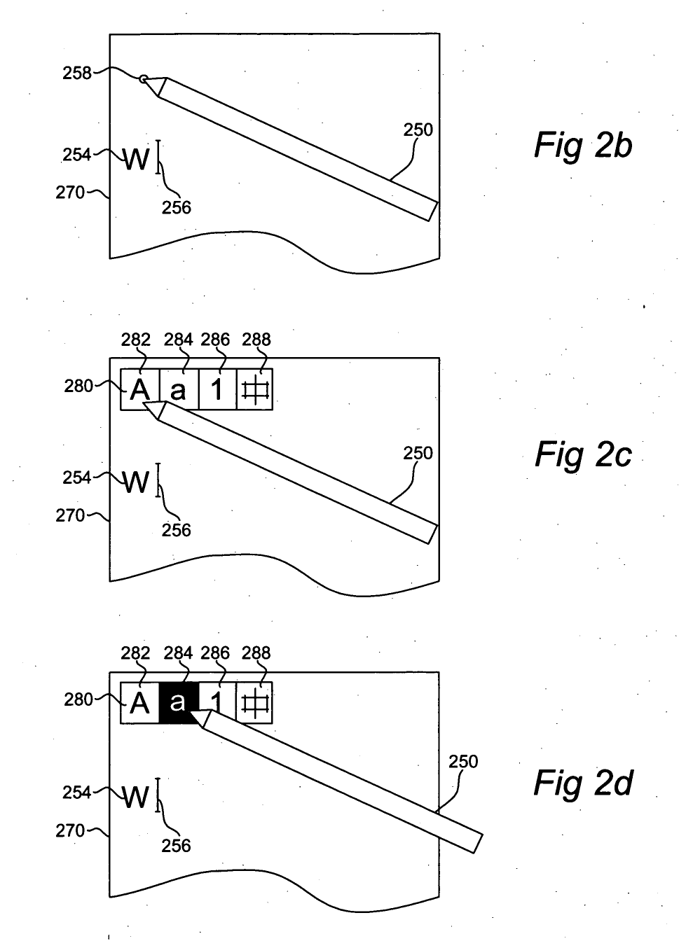

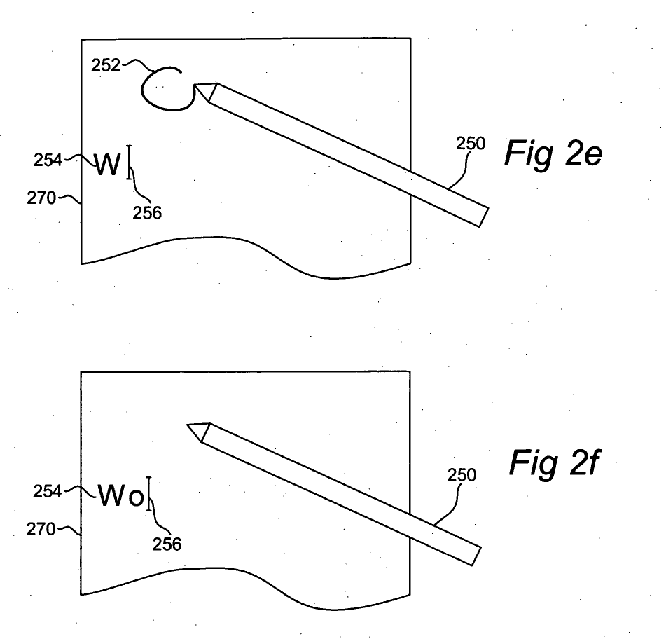

In the telecommunications system of FIG. 1, various telecommunications services such as voice calls, data calls, facsimile transmissions, music transmissions, still image transmissions, video transmissions, electronic message transmissions and electronic commerce may be performed by way of an apparatus or mobile terminal 100. The apparatus 100 is connected to a mobile telecommunications network 110 through an RF link 102 via a base station 104, as is well known in the art. The mobile telecommunications network 110 may be any commercially available mobile telecommunications system, such as GSM, UMTS, D-AMPS or CDMA2000. The apparatus 100 is illustrated as a mobile (cellular) telephone but may alternatively be another kind of portable device, such as a personal digital assistant (PDA), a communicator or a hand-held computer. As will be explained in more detail with reference to FIGS. 2a-i, the apparatus 100 has a stylus-operated user interface including a touch-sensitive display screen onto which a user may enter hand-written information as well as operational commands by way of a stylus, pen or similar writing tool.

In the illustrated example, the apparatus 100 may be used for speech communication with users of other devices. Hence, speech may be communicated with a user of a stationary telephone 132 through a public switched telephone network (PSTN) 130 and the mobile telecommunications network 110, and with a user of another mobile terminal 100′ which is connected to the mobile telecommunications network 110 over a wireless communication link 102′ to a base station 104′.

The mobile telecommunications network 110 is operatively connected to a wide area network 120, which may be Internet or a part thereof. Thus, the apparatus 100 may access a computer 122 connected to the wide area network 120 in accordance with specified protocols (such as TCP, IP and HTTP) and appropriate application software (such as a WAP or WWW browser, an email or SMS application, etc) in the apparatus 100.

The system illustrated in FIG. 1 serves exemplifying purposes only.

FIG. 2a illustrates the apparatus 100 of FIG. 1 in more detail. The apparatus 100 has an apparatus housing 210. A front surface 220 of the portable communication apparatus 100 has a speaker 230, a microphone 232 and a touch-sensitive display screen 240. As is well known in the art, the touch-sensitive display screen 240 constitutes not only an output device for presenting visual information to the user, but also an input device.

In more particular, by pointing, tapping, clicking or dragging a stylus 250 on the display screen 240, the user may use the stylus 250 as a logical mouse to control the user interface of the apparatus 100 by e.g. scrolling and selecting in different menus 260, 262, 264 and their menu options, setting the position of a cursor 256 on the display screen 240, actuating selectable control elements such as icons or click buttons 266, 268, selecting check boxes, controlling scroll bars, etc.

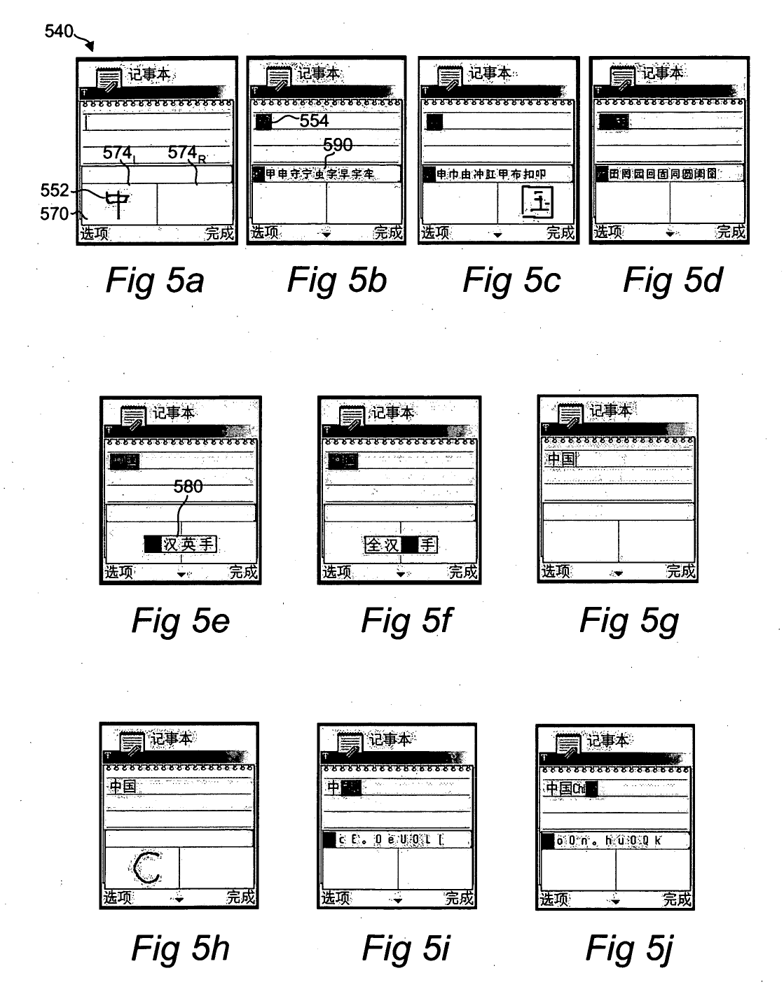

Moreover, the stylus 250 may be used as a logical pen to enter hand-written information within a handwriting input area 270. In the embodiment of FIG. 2a, the handwriting input area 270 is indicated as a dashed rectangle and occupies a majority of the available presentation area of the display screen 240. In other embodiments, the handwriting input area may occupy essentially the entire handwriting input area or only a specific limited portion thereof. FIGS. 5a-5j show an example of the latter alternative.

The hand-written information may be entered into various software applications, such as a messaging application (email, SMS, MMS), a calendar application, a notes or word processor application, a contacts application, etc. Hand-written input within the handwriting input area 270 is processed by a handwriting recognition engine in an attempt to interpret the input as a symbol out of a current symbol set. In the situation in FIG. 2a, a symbol 252 is currently being written in the form of at least one pen stroke made by the stylus 250 on the display screen 240. Four preceding symbols have already been hand-written and interpreted as “W”, “o”, “r” and “l”, respectively, as seen at 254. A graphical trace is presented on the display screen to represent the handwritten input. When a complete pen stroke, or a sequence of pen strokes written within a short time interval, has been written, the handwriting recognition engine will start interpreting the hand-written input to identify the symbol that best matches the hand-written input. After successful interpretation, the recognized symbol is presented in “plain text” at the cursor 256 and replaces the graphical trace 252.

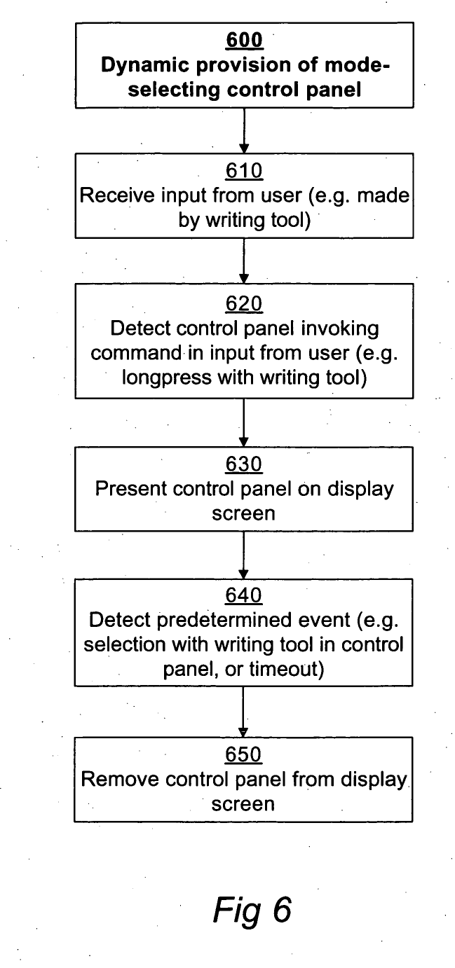

The user interface of the handwriting apparatus 100 is operable in different modes, each being associated with a respective symbol set to be used by the handwriting recognition engine when matching a handwritten input. The novel and inventive way in which the user selects mode, and thereby also the current symbol set, by way of dynamic provision of a mode-selecting control panel will now be explained with reference to FIGS. 2b-2i and FIG. 6.

As seen in FIG. 2a, when the apparatus is in a certain current mode and handwriting is to be interpreted against the current symbol set associated with the current mode, there is no control panel shown on the display screen 240. Thus, in FIG. 2a, the current symbol set is lower-case letters and the user is about to write another lower-case letter, namely “d”. Therefore, for the time being, there is no need for the user to switch modes and consequently no current need for a mode-selecting control panel.

However, moving back in time to the state shown in FIG. 2b, the situation was different. Here, the current symbol set is upper-case letters, and the user has made a hand-written input which has been successfully interpreted by the handwriting recognition engine against the current symbol set and found to be “W”, as seen at 254. Assuming now that the user wants to write a lower-case letter, he will switch to another mode that is associated with lower-case letters to assure successful interpretation of his intended lower-case input. For convenient access to the mode-selecting control panel, the user will input (step 610) a control panel invoking command to the apparatus 100. In the present embodiment, this command is given in the form of a predefined handwriting action, namely by pointing at the display screen 240 and keeping the stylus 250 in steady contact with the display screen during a certain time period—in other words, a “long-press” on the display screen. In order not to confuse such a long-press input with an intended handwriting stroke, the apparatus 100 may be configured to handle the input as a control panel invoking command if during the aforesaid time period the stylus 250 either remains at exactly the same position on the display screen, or is moved only within a very limited area 258 around the position which the stylus initially points at (to allow for accidental small stylus movements caused by hand wobbling), and otherwise as a handwriting stroke to be further interpreted by the handwriting recognition engine. In other embodiments, the control panel invoking command may be given in the form of other actions with the stylus 250 (as has already been mentioned), or as an actuation of another input device of the apparatus 100, such as a mechanical key on the apparatus housing.

Once the control panel invoking command has been detected (step 620), a control panel 280 will be shown on the display screen 240 (step 630), as seen in FIG. 2c. In the present embodiment, the control panel 280 is shown within the handwriting input area 270 at or close to the position 258 where the long-press was made. In this way, the control panel 280 will be conveniently close to the current position of the stylus. In other embodiments, the control panel may be shown at a stationary rather than adaptive location within or outside the handwriting input area 270. In the disclosed embodiment, the control panel 280 has the form of a bar, divided into four clickable sub areas or buttons 282-288 representing the following respective symbol sets: upper-case Latin letters, lower-case Latin letters, Arabic numerals and Chinese characters. Each sub area contains a graphical icon that indicates the meaning of its associated symbol set.

Now, the user may conveniently select the desired symbol set by tapping with the stylus 250 on the corresponding one of the sub areas 282-288, i.e. by applying a logical-mouse pen-down. In FIG. 2d, the user thus selects sub area 284 for lower-case Latin letters, wherein this sub area will be highlighted and the apparatus 100 changes mode accordingly to render the lower-case symbol set the currently active one.

Because of the selection of this new mode, the next hand-written input, at 252 in FIG. 2e, will be successfully interpreted against the lower-case symbol set as an “o” (FIG. 2f). More importantly, the control panel 280 is removed from presentation on the display screen 240 (step 650) once a predetermined event occurs (step 640) and therefore no longer occupies display space. In the disclosed embodiment, the predetermined event is when the user makes a selection in the control panel 280 (such as the selection of the sub area 284 in FIG. 2d). Alternatively or in combination, the predetermined event may be the lapse of a timeout period, or a stylus click outside the control panel.

One of the available modes/symbol sets is preferably used as a default mode/symbol set, i.e. the mode/symbol set used at start-up or when the user has not made any active selection. Different applications, and different scenarios or input fields in the same application, may have different default modes/symbol sets. For instance, an application that predominantly handles numeric input, such as a telephone dialer or a calculator, may use Arabic numerals as default, whereas a text handling application may be defaulted to a symbol set which is determined e.g. by a general language setting for the user interface.

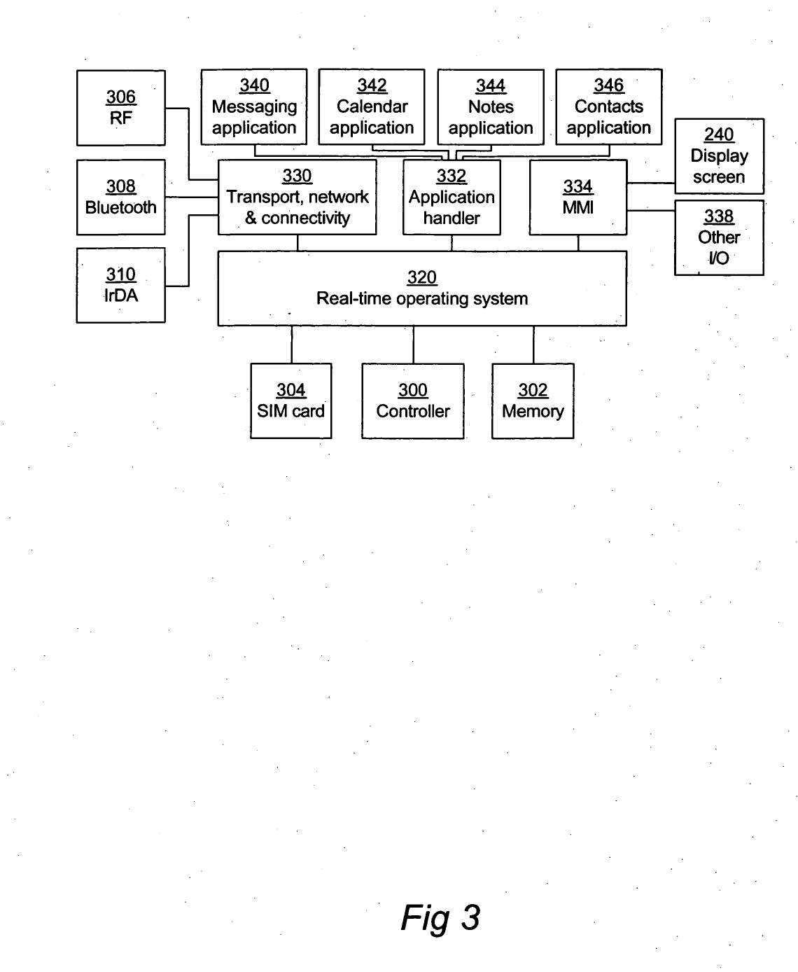

FIG. 3 illustrates the internal structure of the apparatus 100. A controller 300 is responsible for the overall operation of the apparatus and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the apparatus 100. The software includes a real-time operating system 320, a man-machine interface (MMI) drivers 334, an application handler 332 as well as various applications. The applications include a messaging application 340, a calendar application 342, a notes application 344 and a contacts application 346, as well as various other applications which are not referred to herein. The MMI drivers 334 cooperate with various MMI or input/output (I/O) devices, including the display screen 240 and other input/output devices 338 such as a camera, a keypad, the microphone 232, the speaker 230, a vibrator, a joystick, a ring tone generator, an LED indicator, etc. As is commonly known, a user may operate the apparatus through the man-machine interface thus formed.

The functionality described above for dynamic provision of a mode-selecting control panel, as well as the handwriting recognition engine, may be included in the set of MMI drivers 334 or may be provided as separate software executable by the controller 300. A large variety of existing handwriting recognition algorithms and products, software-based and/or hardware-based, may be used to implement the handwriting recognition engine, as is readily realized by the skilled person.

The software also includes various modules, protocol stacks, drivers, etc., which are commonly designated as 330 and which provide communication services (such as transport, network and connectivity) for an RF interface 306, a Bluetooth interface 308 and an IrDA interface 310. The RF interface 306 comprises an internal or external antenna as well as appropriate radio circuitry for establishing and maintaining a wireless link to a base station (e.g. link 102 to base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The apparatus 100 also has a SIM card 304 and an associated reader. As is commonly known, the SIM card 304 comprises a processor as well as local work and data memory.

The handwriting input referred to above may be received and used for various purposes in a variety of applications, including aforesaid messaging, calendar, notes and contacts applications 340, 342, 344 and 346, as well as for instance an Internet browser application, a WWW browser application, a WAP browser application, a phonebook application, a camera application, an imaging application, a video recording application, an organizer application, a video game application, a calculator application, a voice memo application, an alarm clock application, a word processing application, a code memory application, a music player application, a media streaming application, and a general control panel/settings application, or any other application which uses at least one field for text, character or symbol input.

The control panel 280 may be designed in many different ways. It may be divided into an arbitrary number of sub areas (2, 3, 4 (as in FIGS. 2c-2d), 5, 6, ...), each representing a respective symbol set and mode as described above. Moreover, the control panel 280 may have a fixed location on the display screen, or, as already explained, an adaptive location depending on a current cursor position or point of stylus actuation. If the control panel 280 has a fixed location, it may in some embodiments be included in a status or menu bar which also includes status information such as battery level, RSSI (Received Signal Strength Indicator), date, time, application name, document name, number of characters in a document, etc, and/or selectable menus.

The control panel 280 need not necessarily be designed as a horizontal bar but have other geometrical forms, for instance a vertical bar, a circle or a square box. If the control panel 280 is a square box, its sub areas may be positioned like quadrants in a coordinate system.

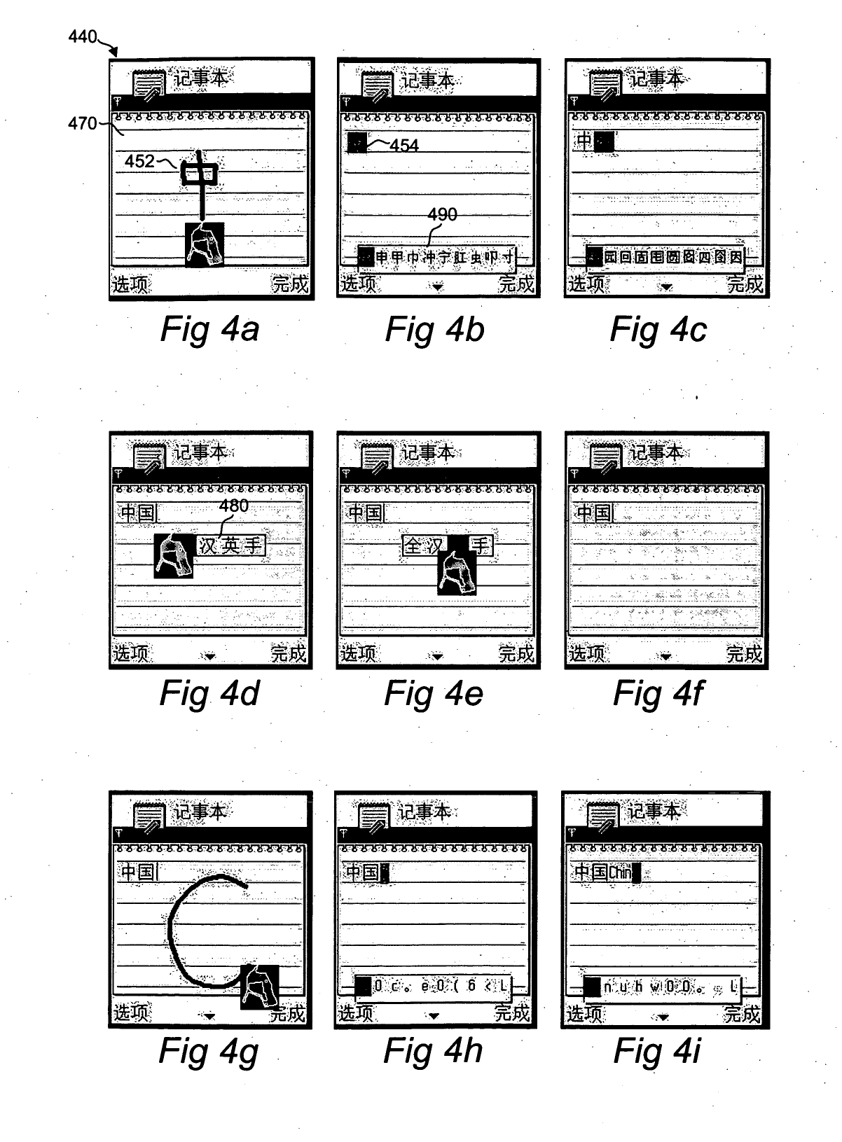

FIGS. 4a-4i disclose a sequence of display screen snapshots taken from a practical implementation of the apparatus when used for inputting a hand-written text made of symbols from both a Chinese symbol set and a Latin character set into a notes application. Another practical implementation is shown in FIGS. a-5j. Like reference numerals represent the same or equivalent element in these FIGS as in FIGS. 2a-2f; the display screen 440/540 corresponds to display screen 240, etc. As seen in FIGS. 4a-4c, the two Chinese characters that make up the word “China” are written as Chinese symbols 452 and interpreted into plain-text characters 454 by matching against a default Chinese symbo set. Element 490 is a symbol predictor bar which displays the most likely symbols, as determined by the handwriting recognition engine, and offers the user to select any of these by the stylus. The most likely symbol is shown at the leftmost position and is highlighted; if the user is satisfied with this (i.e., this symbol is the one he intended to write), he need not make any selection in the symbol predictor bar 490.

Then, in FIG. 4d, the user brings about the mode-selecting control bar 480, e.g. by a long-press with the stylus as explained above, and instead selects a Western (Latin) symbol set in FIG. 4e. The control bar 480 disappears automatically from the display screen 440 in FIG. 4f. Following this, the user writes the five Latin characters that make up the word “China” in the Latin alphabet, as seen in FIGS. 4g-4i.

The procedure is roughly the same in FIGS. 5a-5j. Here, however, the handwriting input area 570 is a limited-sized area consisting of two character input boxes 574_{L}, 574_{R}. The user writes his input 552 alternately in these two boxes.

The invention has mainly been described above with reference to a few embodiments. However, as is readily appreciated by a person skilled in the art, other embodiments than the ones disclosed above are equally possible within the scope of the invention, as defined by the appended patent claims.

1. An apparatus for handwriting recognition, the apparatus comprising:
a display screen providing a handwriting input area capable of detecting input from a user;
a processing device coupled to the display screen and providing a handwriting user interface to said user, said handwriting user interface being operable in at least a first mode and a second mode; and
a control panel in said handwriting user interface for selecting said first or second mode;
wherein said processing device is adapted to:
receive an input from said user,
detect, in the input received from said user, a control panel invoking command,
in response to detecting the control panel invoking command, cause presentation of said control panel on said display screen, and
in response to a predetermined event, remove said control panel from presentation on said display screen.

2. The apparatus as defined in claim 1, wherein the control panel invoking command detected in the input received from said user is a predefined handwriting action made with a writing tool on said display screen.

3. The apparatus as defined in claim 2, wherein said predefined handwriting action is caused by said user by pointing with said writing tool on said display screen at a stationary position thereon for at least a predetermined time period without removing said writing tool from pointing.

4. The apparatus as defined in claim 2, wherein said predefined handwriting action is caused by said user by pointing a first time with said writing tool on said display screen at a position thereon, removing said writing tool from pointing at said position, and pointing a second time with said writing tool at said position within a predetermined time period.

5. The apparatus as defined in claim 1, wherein said predefined handwriting action is caused by said user by performing a predetermined gesture with said writing tool on said display screen.

6. The apparatus as defined in claim 5, wherein said predetermined gesture involves one of the following: writing a predetermined symbol different from symbols for which handwriting recognition is performed; writing a predetermined symbol having a size which is substantially different from a typical size of symbols for which handwriting recognition is performed; and drawing a stroke which crosses at least a predetermined part of said handwriting input area.

7. The apparatus as defined in claim 5, wherein said predetermined gesture is configurable by a user of the apparatus.

8. The apparatus as defined in claim 1, wherein said predetermined event is the detection of an action made with a writing tool within said control panel.

9. The apparatus as defined in claim 1, wherein said predetermined event is the absence of an action made with a writing tool within said control panel during a predetermined time.

10. The apparatus as defined in claim 8, said control panel comprising a first selectable item for selection of said first mode and a second selectable item for selection of said second mode, wherein the action made with said writing tool within said control panel involves selecting one of said first and second items.

11. The apparatus as defined in claim 1, said handwriting recognition involving interpreting hand-written user input in the handwriting input area as a symbol among predefined symbols, wherein said first and second modes are associated with first and second sets of predefined symbols, respectively, to be used for said interpretation of hand-written user input.

12. The apparatus as defined in claim 11, said handwriting user interface further being operable in at least a third mode, said control panel being adapted for selecting between any of said first, second and third modes, wherein said third mode is associated with a third set of predefined symbols to be used for said interpretation of hand-written user input.

13. The apparatus as defined in claim 1, wherein said control panel has an adaptive location within said handwriting input area on said display screen, said processing device being configured to adjust said adaptive location depending on at least one of the following: a current cursor position or a current point of actuation on said display screen with a writing tool.

14. The apparatus as defined in claim 1, in the form of a mobile terminal for a mobile telecommunications system, a personal digital assistant (PDA), or a hand-held computer.

15. A method for handwriting recognition in an apparatus having a display screen with a handwriting input area capable of detecting input from a user, the display screen being included in a handwriting user interface which is operable in at least a first mode and a second mode, the method involving the steps of:
receiving an input from said user;
detecting, in the input received from said user, a control panel invoking command;
causing presentation on said display screen of a control panel suitable for selection of said first or second mode;
detecting the occurrence of a predetermined event; and
removing said control panel from presentation on said display screen.

16. The method as defined in claim 15, wherein said step of detecting the control panel invoking command involves detecting a predefined handwriting action made with a writing tool on said display screen.

17. The method as defined in claim 16, wherein said step of detecting the control panel invoking command involves detecting that said user points with said writing tool on said display screen at a stationary position thereon for at least a predetermined time period without removing said writing tool from pointing.

18. The method as defined in claim 16, wherein said step of detecting the control panel invoking command involves detecting that said user points a first time with said writing tool on said display screen at a position thereon, removes said writing tool from pointing at said position, and points a second time with said writing tool at said position within a predetermined time period.

19. The method as defined in claim 15, wherein said step of detecting the control panel invoking command involves detecting that said user performs a predetermined gesture with said writing tool on said display screen.

20. The method as defined in claim 19, wherein said predetermined gesture includes one of the following: writing a predetermined symbol different from symbols for which handwriting recognition is performed; writing a predetermined symbol having a size which is substantially different from a typical size of symbols for which handwriting recognition is performed; and drawing a stroke which crosses at least a predetermined part of said handwriting input area.

21. The method as defined in claim 15, wherein said step of detecting the occurrence of a predetermined event involves detecting an action made with a writing tool within said control panel.

22. The method as defined in claim 15, wherein said step of detecting the occurrence of a predetermined event involves detecting that an action has not been made with a writing tool within said control panel during a predetermined time.

23. The method as defined in claim 21, said control panel comprising a first selectable item for selection of said first mode and a second selectable item for selection of said second mode, wherein the action made with said writing tool within said control panel involves selecting one of said first and second items.

24. The method as defined in claim 15, said handwriting recognition involving interpreting hand-written user input in the handwriting input area as a symbol among predefined symbols, wherein said first and second modes are associated with first and second sets of predefined symbols, respectively, to be used for said interpretation of hand-written user input.

25. The method as defined in claim 24, said handwriting user interface further being operable in at least a third mode, said control panel being adapted for selecting between any of said first, second and third modes, wherein said third mode is associated with a third set of predefined symbols to be used for said interpretation of hand-written user input.

26. The method as defined in claim 15, involving the steps of
determining a current cursor position on said display screen; and
adjusting an adaptive location of said control panel within said handwriting input area on said display screen depending on the determined cursor position.

27. The method as defined in claim 15, involving the steps of
determining a current point of actuation on said display screen with a writing tool; and
adjusting an adaptive location of said control panel within said handwriting input area on said display screen depending on the determined point of actuation.
